(19) United States
(12) Patent Application Publication
(10) Pub. No.: US 2005/0285524 A1
(43) Pub. Date: Dec. 29, 2005

(54) Gas discharge panel and manufacturing method therefor

(75) Inventors: Akira Tokai, Kawasaki (JP); Osamu Toyoda, Kawasaki (JP); Kazunori Inoue, Kawasaki (JP)

Correspondence Address: STAAS & HALSEY LLP, SUITE 700, 1201 NEW YORK AVENUE, N.W., WASHINGTON, DC, 20005, US

(73) Assignees: Fujitsu Limited, Kawasaki (JP); Advanced PDP Development Center Corporation, Tokyo (JP)

(21) Appl. No.: 10/983,685

(22) Filed: Nov. 9, 2004

(30) Foreign Application Priority Data
Jun. 25, 2004 (JP) 2004-187296

(51) Int. Cl. H01J 17/49

(52) U.S. Cl. 313/582

(57) ABSTRACT

The present invention provides a new technology for an electrode that can be used for a gas discharge panel, a substrate for a gas discharge panel, a gas discharge panel and a gas discharge panel display device. On the rib formation surface of a substrate for a gas discharge display panel, a self-assembled monolayer is formed, a part of the self-assembled monolayer is activated so that a substance to be a plating catalyst can adhere thereto, the substance to be the plating catalyst is caused to adhere to this activated part to form the plating catalyst, and address electrodes are formed by forming an electroless plating layer on the top of the part of the self-assembled monolayer by an electroless plating method using the plating catalyst.

### CROSS-REFERENCE TO RELATED APPLICATIONS

This application is based upon and claims the benefit of priority from the prior Japanese Patent Application No. 2004-187296, filed on Jun. 25, 2004, the entire contents of which are incorporated herein by reference.

### BACKGROUND OF THE INVENTION

1. Field of the Invention

The present invention relates to a gas discharge panel such as a plasma display (PDP). And more particularly the present invention relates to a back substrate of a gas discharge panel.

2. Description of the Related Art

Recently a fabrication process for a surface-discharge type PDP has been established and large-screen PDP display devices are being produced. However, although a mass production process has been established, a decrease in cost of the panel fabrication process is still in demand.

As a panel manufacturing method with a decreased process cost, a method in which ribs (partitions) to partition the gas discharge are formed by directly cutting a glass substrate was proposed (e.g. Japanese Patent Application Laid-Open No. 2000-348606 and Japanese Patent Application Laid-Open No. 2001-6537).

In this method, the printing step and the baking step of low melting point glass of the conventional steps are eliminated and the material cost of low melting point glass is made unnecessary, so low cost is implemented. However, address electrodes, which are conventionally formed before forming ribs, must be formed after forming the ribs by directly cutting the glass substrate in this method.

### SUMMARY OF THE INVENTION

In the case of the above mentioned method for forming ribs by directly cutting a glass substrate, the address electrodes are formed in areas between the ribs. However, the overall yield is poor, when conventional photolithography and etching steps are used for forming electrodes in areas between the ribs which are formed by directly cutting the glass substrate,.

The reason for the poor yield is that there are convex portions of the ribs and concave portions between the ribs existing on the substrate, which result in many parts where bubbles become caught or the resist is repelled when a resist is coated in the conventional method using photolithography and etching. Accordingly, the probability of defects that would result in disconnection becomes high

It is an object of the present invention to provide a new technology to avoid the shortcomings of such a method. Other objects and advantages of the present invention will be clarified from the following description.

An aspect of the present invention provides a manufacturing method for a substrate for a gas discharge panel, comprising; forming a self-assembled monolayer on a rib formation surface of a substrate for a gas discharge panel, activating a part of the self-assembled monolayer so that a substance to be a plating catalyst can adhere thereto, forming the plating catalyst by causing the substance to be the plating catalyst to adhere to the activated part, and forming an electroless plating layer on the top of the part of the self-assembled monolayer by an electroless plating method using the plating catalyst.

Another aspect of the present invention provides a gas discharge panel comprising a pair of substrates that face each other, wherein one of the pair of substrates has ribs on the side facing the other substrate, a self-assembled monolayer is formed on the rib formation surface of the substrate having the ribs, a part of the self-assembled monolayer is activated so that a substance to be a plating catalyst can adhere thereto, the plating catalyst is formed by causing the substance to be the plating catalyst to adhere to the activated part, and an electroless plating layer is formed on the top of the part of the self-assembled monolayer by an electroless plating method using the plating catalyst, or a gas discharge panel comprising a pair of substrates that face each other, wherein one of the pair of substrates has ribs on the side facing the other substrate, a self-assembled monolayer having a polysiloxane structure, a plating catalyst layer and an electroless plating layer are formed in this sequence between the ribs on the rib formation surface of the substrate having the ribs.

Another aspect of the present invention is a gas discharge panel display device comprising a pair of substrates that face each other, wherein one of the pair of substrates has ribs on the side facing the other substrate, and a self-assembled monolayer is formed on the rib formation surface of the substrate having the ribs, a part of the self-assembled monolayer is activated so that a substance to be a plating catalyst can adhere thereto, the plating catalyst is formed by causing the substance to be the plating catalyst to adhere to the activated part, and an electroless plating layer is formed on the top of the part of the self-assembled monolayer by an electroless plating method using the plating catalyst, or a gas discharge panel display device comprising a pair of substrates that face each other, wherein one of the pair of substrates has ribs on the side facing the other substrate, and a self-assembled monolayer having a polysiloxane structure, a plating catalyst layer, and an electroless plating layer are comprised in this sequence between the ribs on the rib formation surface of the substrate having the ribs.

By these aspects of the present invention, a new technology can be provided for an electrode that can be used for a gas discharge panel, substrate for a gas discharge panel, gas discharge panel and gas discharge panel display device.

In these aspects, it is preferable, if possible, to perform the electrolytic plating using the electroless plating layer as an electrode after forming the electroless plating layer to form an electrolytic plating layer on the electroless plating layer, or that a compound for forming the self-assembled monolayer is an organic silane compound which may be branched and has a group that can be bound to the surface of the substrate and a group that can be activated so that the substance to be the plating catalyst can adhere thereto, or that the group that can be bound to the surface of the substrate is a hydroxy group or a group that can be hydrolyzed to form a hydroxy group, or that the group that can be hydrolyzed to form a hydroxy group is a halogen group, or that the group that can be activated so that the substance to be the plating catalyst can adhere thereto is at least either one of a phenyl group and an alkyl group, or that the part of the self-assembled monolayer is activated by irradiation with UV rays through a photo mask so that the substance to be the plating catalyst can adhere thereto, or that the plating catalyst is a palladium catalyst, or that the thickness of the electroless plating layer is in a range of 0.2 to 0.3 μm, or that the total of the thickness of the electroless plating layer and the electrolytic plating layer is in a range of 2 to 4 μm, or that the height of the ribs is in a range of 100 to 250 μm, and the space between the ribs is in a range of 50 to 330 μm.

In this way, the present invention can provide a new technology for an electrode that can be used for a gas discharge panel, a substrate for a gas discharge panel, a gas discharge panel, and a gas discharge panel display device. The shortcomings of the conventional method can also be avoided.

### BRIEF DESCRIPTION OF THE DRAWINGS

FIG. 1 is a schematic exploded view depicting an example of a conventional PDP;

FIG. 2 is a schematic cross-sectional view depicting an example of a conventional PDP;

FIG. 3 is a flow chart depicting the sequence of forming address electrodes, a dielectric layer, ribs and a fluorescent layer on a back substrate;

FIG. 4 is a schematic diagram depicting a cross-sectional structure of a PDP by the method for forming ribs by directly cutting a glass substrate;

FIG. 5 is a flow chart depicting the sequence of forming address electrodes, ribs and a fluorescent layer on a back substrate;

FIG. 6 is a flow chart depicting the sequence of forming a SAM, plating catalyst layer and electroless plating layer on a back substrate;

FIG. 7A is a schematic cross-sectional view depicting a substrate portion where a SAM is uniformly formed on a substrate having ribs;

FIG. 7B is a schematic cross-sectional view depicting a substrate portion where activated areas are formed on a substrate having ribs;

FIG. 7C is a schematic cross-sectional view depicting a substrate portion where a plating catalyst layer is formed on a substrate having ribs;

FIG. 7D is a schematic cross-sectional view depicting a substrate portion where an electroless plating layer is formed on a substrate having ribs;

FIG. 8A is a diagram depicting an image where a SAM is formed on a substrate using phenyltrichlorosilane;

FIG. 8B is a diagram depicting an image of irradiation with UV rays through a photo mask;

FIG. 8C is a diagram depicting an image where a hydroxy group is generated in an area where UV rays are irradiated, thus forming an activated area; and

FIG. 8D is a diagram depicting an image of a status where Pd⁺ is attracted and attached to a hydroxy group generated in an area to which UV rays are irradiated.

### DESCRIPTION OF THE PREFERRED EMBODIMENTS

Embodiments of the present invention will now be described using drawings and examples. These drawings, examples and descriptions are for demonstrating the present invention, and do not limit the scope of the invention. Needless to say, other embodiments can be included in the scope of the present invention as long as they conform to the essential character of the present invention. The same reference numeral indicates the same composing element in the drawings.

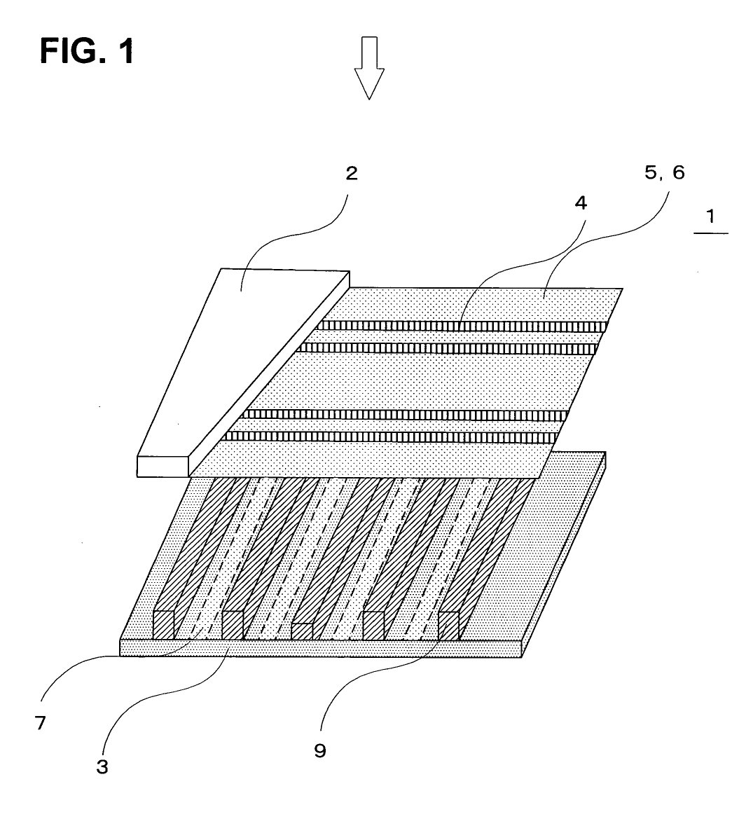

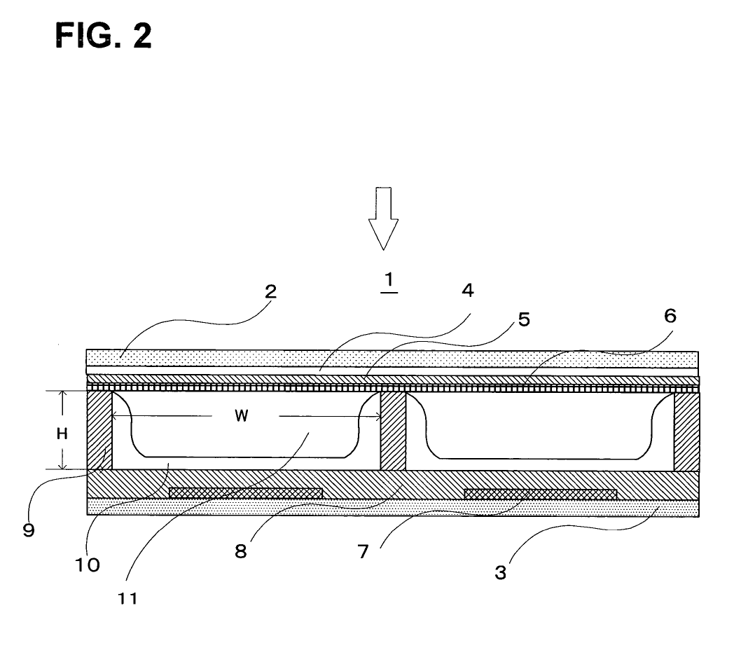

FIG. 1 is an exploded view depicting an example of a conventional PDP and FIG. 2 is a cross-sectional view thereof. In FIG. 1 and FIG. 2, the panel is viewed from the direction of the arrow mark. PDP 1 has a structure where a front substrate 2 and a back substrate 3 face-each other. In this example, display electrodes 4, a dielectric layer 5 and a protective layer 6 for protecting the electrodes are sequentially layered inside the front substrate 2 (the side facing the back substrate 3), and address electrodes 7 and a dielectric layer 8 are sequentially layered inside the back substrate (the side facing the front substrate 2), and ribs 9 and a fluorescent layer 10 are formed thereon. (The dielectric layer 8 and the fluorescent layer 10 are not illustrated in FIG. 1. The address electrodes 7 are indicated by dotted lines.) In the case of a system that causes a maintenance discharge for display by applying voltage between two display electrodes as shown in FIG. 1, the dielectric layer 8 need not be disposed since characteristics do not change much.

In the discharge space 11 enclosed by the dielectric layer 5, ribs 9 and fluorescent layer 10, gas for discharging, such as neon gas or xenon gas, is charged. PDP 1 displays visible light by applying a voltage between two display electrodes to cause a discharge, which excites the gas for discharge, and illuminating the fluorescent substance of the fluorescent layer 10 using UV rays which is generated when the gas molecules return to the ground state. In the PDP, a color filter, electromagnetic wave shielding sheet and anti-reflection film are often installed. By installing an interface with a power supply and turner unit in the PDP, a gas discharge panel display device, such as a large television device (plasma TV), can be obtained.

For the substrate of the PDP, soda-lime glass, high-strain-point glass, etc. are used. For the address electrodes, any metal can be used if it has electroconductivity. Normally copper, silver or the like is used as a main material. For the dielectric layer, a low melting point glass is used. The ribs 9 are made of a low melting point glass.

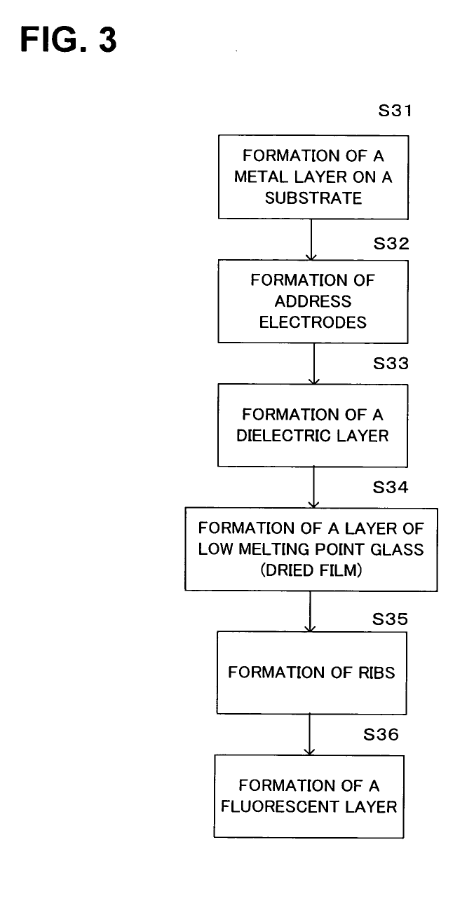

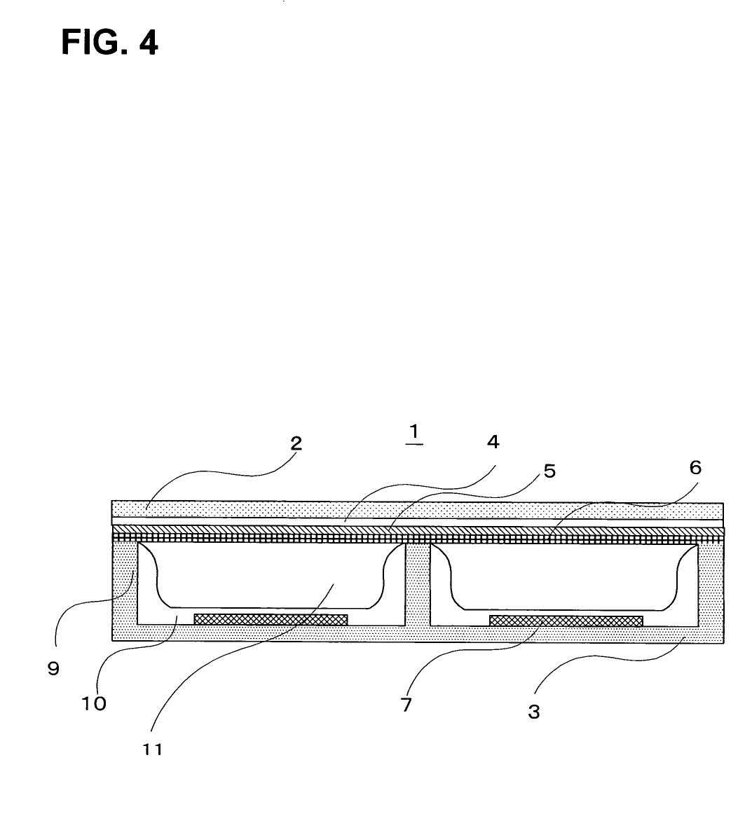

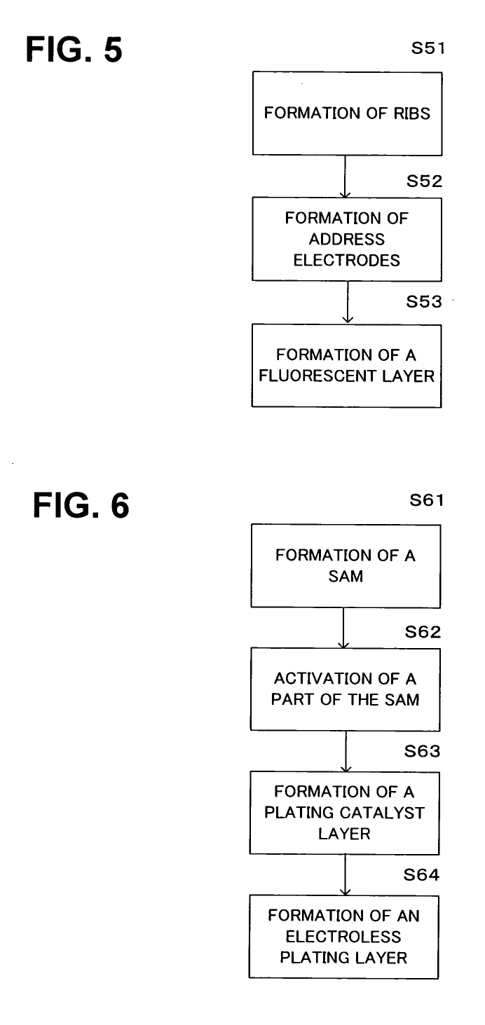

Inside the back substrate 3, the address electrodes 7, dielectric layer 8, ribs 9 and fluorescent layer 10 are formed in the following sequence, for example. At first, a uniform metal layer is formed on the back substrate 3, as in step S31 in FIG. 3. Then as step S32 shows, unnecessary portions are removed and the address electrodes 7 having a specific pattern are formed. Then as step S33 shows, the dielectric layer 8 is formed. Then as step S34 shows, a uniform layer of low melting point glass (dried film) is formed. After this, as step S35 shows, the dried film of the low melting point glass is cut and baked to form the ribs, and as step S36 shows, the fluorescent material is coated.

Whereas in the case of the method for forming the ribs by directly cutting the glass substrate, the cross-sectional structure of the PDP becomes as shown in FIG. 4. In FIG. 4, the dielectric layer 8 is omitted. In this case, the address electrodes 7, ribs 9 and fluorescent layer 10 are formed inside the back substrate 3 in the following sequence, for example. At first, the ribs are formed by directly cutting the glass substrate, as shown in step S51 in FIG. 5. Then as step S52 shows, the electrodes are formed in the areas between the ribs. Then as step S53 shows, the fluorescent substance is coated thereon. To form electrodes in areas between ribs, a method wherein a metal film is formed on the entire surface by sputtering or the like, the resist pattern for electrodes is formed by photolithography, and unnecessary portions of the metal film are removed by etching, can be employed.

Electrodes in this case (address electrodes) can be easily fabricated by forming a self-assembled monolayer (hereafter called a SAM: SELF-ASSEMBLED MONOLAYER or SELF-ASSEMBLED MEMBRANE) on the rib formation surface of the substrate for a gas discharge panel on which the ribs are formed (which corresponds to the back substrate 3 in the above example), activating a part of this SAM so that a substance to be a plating catalyst can adhere thereto, then forming the plating catalyst by causing the substance to be the plating catalyst to adhere to this activated part, and forming an electroless plating layer on the top of the part of the SAM by an electroless plating method using this plating catalyst. The electrolytic plating layer formed on the electroless plating layer may be used as address electrodes. Part of the electroless plating layer and/or electrolytic plating layer may also be used as a wiring layer other than address electrodes.

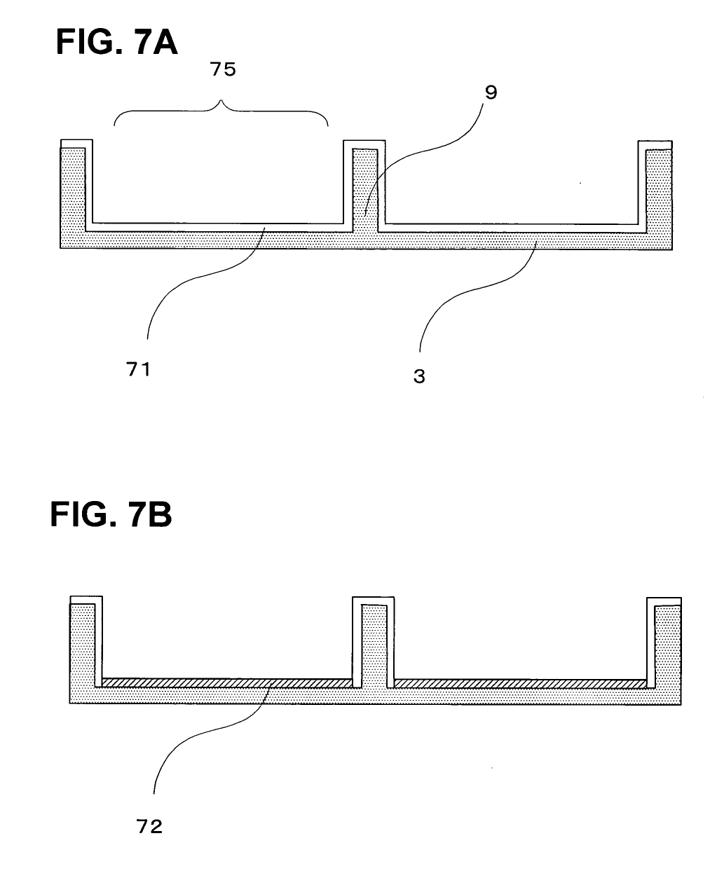

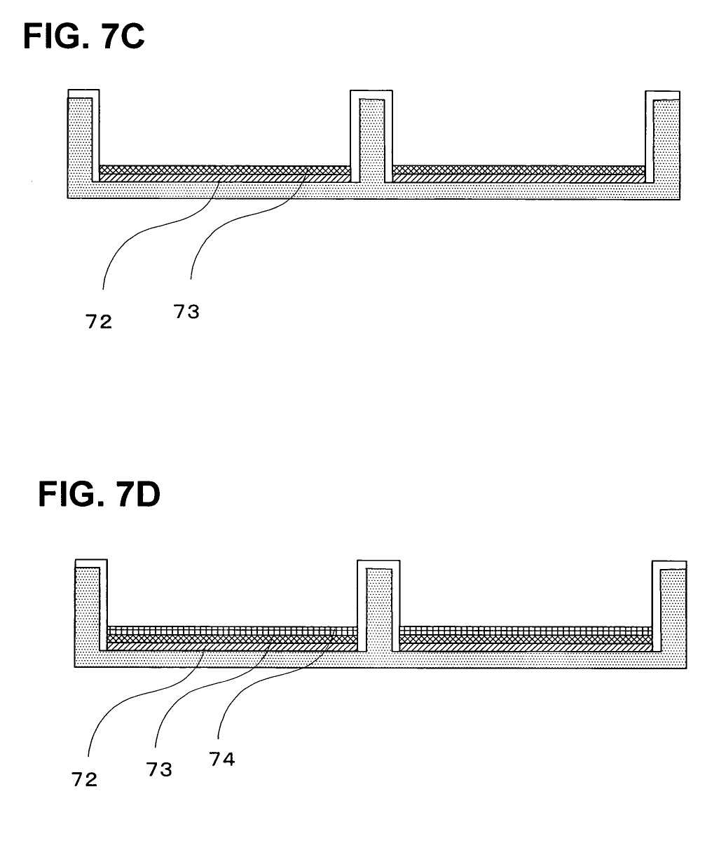

FIG. 6 and FIGS. 7A-D show this status. At first, a SAM 71 is uniformly formed on a substrate having ribs, as shown in FIG. 7A, according to step S61. Then according to step S62, a part of this SAM is activated so that a substance to be a plating catalyst can adhere thereto, and activated areas 72 are obtained, as shown in FIG. 7B. The activated areas 72 have a pattern matching with the electrode pattern. Then according to step S63, the substance to be the plating catalyst is caused to adhere to the activated areas 72 to form a plating catalyst layer 73, as shown in FIG. 7C, and according to step S64, an electroless plating layer 74 is formed on the top of the above mentioned “part of the SAM” (that is, on the top of the plating catalyst layer 73), as shown in FIG. 7D. The SAM 71, activated areas 72, plating catalyst layer 73 and electroless plating layer 74 are all extremely thin layers, but are shown as thick layers in FIGS. 7A-D for easier understanding. After forming the electroless plating layer, electrolytic plating may be performed using this electroless plating layer as an electrode so as to form an electrolytic plating layer on the electroless plating layer. In this way, a desired electrode pattern can be obtained. About 0.2-0.3 μm is often sufficient for the thickness of the electrode pattern if there is only the electroless plating layer. And the thickness may be in a range of 2-4 μm if the electrolytic plating layer is formed thereon.

The present invention can be applied to a case of forming electrodes on a substrate for a gas discharge panel having ribs formed thereon, so the present invention is particularly useful for a case of forming electrodes on a substrate where ribs are formed by directly processing the substrates, while it can also be applied to a case of forming electrodes after forming ribs using a low melting point glass, for example. By forming a SAM and activating a part of the surface thereof, a pattern to be a base of the later formed electrode pattern can be formed easily, which can contribute to simplifying the manufacturing steps and improving the yield of the products.

Generally a SAM refers to an extremely thin film that has regularity, such as a monomolecular film, which is spontaneously formed on a metal or inorganic surface using, for example, a regular atomic arrangement of the surface of a monocrystal as a mold, but the SAM in the present invention is based on a concept that is wider than this, where if a substance can adhere to the surface of a substrate by contacting the substrate to the substance, a plating catalyst can adhere to a particular part of the surface of the substance when the part of the surface is activated and a substance to be the plating catalyst is made to act on the activated surface, and an electroless plating layer can be formed by electroless plating using the plating catalyst, it is regarded that a SAM is formed.

Attachment of the substance to the substrate may be confirmed by an FT-IR (Fourier Transform InfraRed spectrophotometer) or the like after cleaning the substrate by an appropriate solvent, for example, but confirmation is not really necessary and it is sufficient to check whether an electroless plating layer has been formed. If the strength of attachment to the substrate is a critical issue, then a peel test of the electroless plating layer can be performed.

After forming the plating catalyst layer, electroless plating layer, electrolytic plating layer, etc., it is possible that the SAM may not exist any longer in the ordinary sense, such as in a case where the SAM is chemically or physically denatured, becoming silicon or carbon residues, for example. Therefore cases where the electrode, substrate for a gas discharge panel, gas discharge panel and gas discharge panel display device according to the present invention themselves do not have a SAM any longer in the ordinary sense should also be regarded as within the scope of the present invention. For example, when discussing a SAM according to the present invention having a polysiloxane structure, a case where only a residue of a polysiloxane structure is recognized as a result of analysis, as well, is regarded as within the scope of a “SAM having a polysiloxane structure” of the present invention. The “self-assembled monolayer having a polysiloxane structure” of a gas discharge panel according to the present invention, comprising a pair of substrates facing each other, where one of the pair of substrates has ribs on the side facing the other substrate and the self-assembled monolayer having a polysiloxane structure, plating catalyst layer and electroless plating layer are formed in this sequence between the ribs on the rib formation surface of the substrate having ribs, should also be interpreted in the above sense.

Activation according to the present invention refers to making it possible for a plating catalyst to attach only to a particular part of the surface of a SAM as a result of making a substance to be the plating catalyst act on the surface. Whether the substance has become the plating catalyst or not can be easily confirmed by actually performing electroless plating.

For activation according to the present invention, any method can be used if it supports the object of the invention. For example, if a hydroxy group is generated by hydrolysis, using a combination of contacting with water, or moisture, an acid, an alkali or the like in air, and the irradiation of active energy rays such as UV rays, then the hydroxy group can be generated only on a particular part of the surface of the SAM by limiting the irradiating area to a part of the substrate using a photo mask. Introduction of a substance which reacts with the hydroxy group to form a plating catalyst after this processing, will make it possible for the plating catalyst to adhere only to this particular part of the surface of the SAM.

For a compound that can form a SAM according to the present invention, any compound can be used as long as it supports the object of the present invention, but a compound that has a group that can be bound to the surface of a substrate and a group that can be activated so that a substance to be a plating catalyst can adhere thereto is preferable. An example of such a compound is an organic silane compound. An organic silane compound may be branched or not. For the silicon of the organic silane compound, two or more silicon atoms may be included in one molecule.

A group that can be bound to the surface of a substrate refers to a group for forming a bond used when a compound to form a SAM bonds to the surface of the substrate to form the SAM. An example of such a group is a hydroxy group or a group that generates a hydroxy group by hydrolysis. If the group that can bond to the surface of a substrate is a hydroxy group itself, then the compound is bound to the surface of the substrate by the hydroxy group, and if the group that can bond to the surface of a substrate is a group which can generate a hydroxy group by hydrolysis, then the compound is bound to the surface of the substrate by selecting a condition under which hydrolysis occurs when contacting with the surface of the substrate. An example of such a group that can be bound to the surface of a substrate and which can generate a hydroxy group by hydrolysis, is a halogen group, more specifically chlorine or bromine. It is preferable that the halogen group is bonded with silicon of an organic silane compound, since hydrolysis easily occurs, and a SAM can be formed easily via a polysiloxane structure. As long as the formation of the activated areas is not interfered with, it is possible to promote bonding to the surface of the substrate by irradiating UV rays or the like.

The group that can be activated so that a substance to be a plating catalyst can adhere thereto is preferably at least either one of a phenyl group and an alkyl group. It is especially preferable that the phenyl group or alkyl group is bonded with the silicon of an organic silane compound. It is considered that a phenyl group or alkyl group is hydrolyzed, which is promoted by UV rays for example, to form a hydroxy group the negative polarity of which makes a substance to be a plating catalyst adhere to the group. In this case, the phenyl group and the alkyl group does not cause hydrolysis, even under conditions where a group that can bond to the surface of a substrate generates a hydroxy group by hydrolysis, and a hydroxy group is generated in a particular part of the surface of a SAM only when UV rays are also used through a photo mask. Accordingly, a substance to be a plating catalyst can adhere to this particular part.

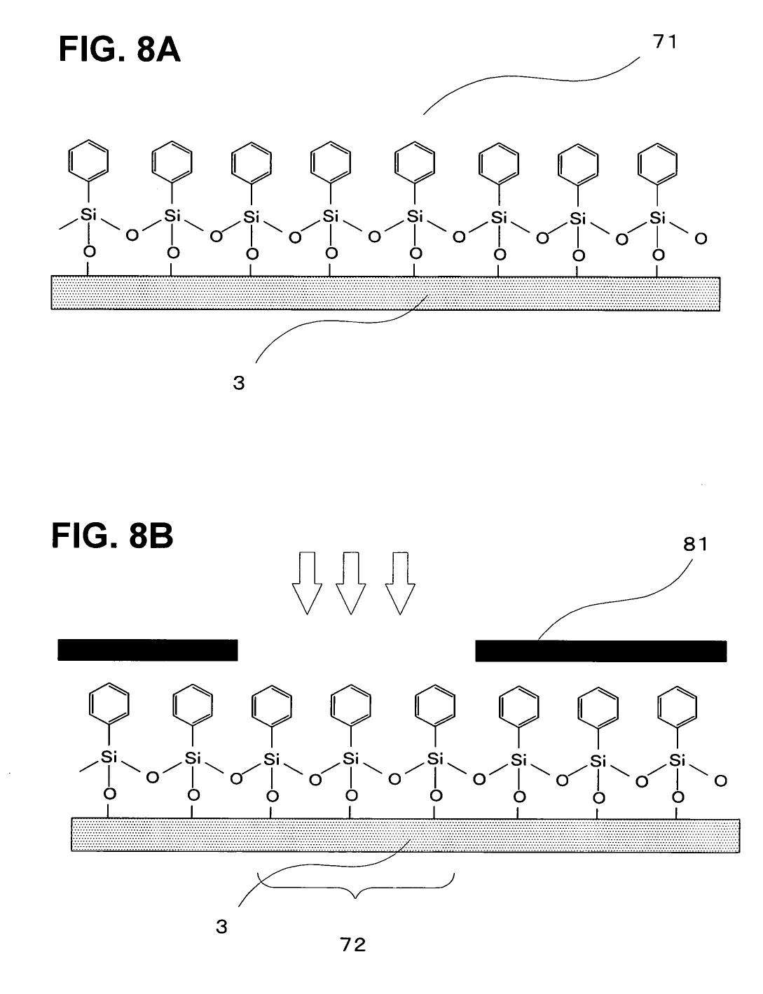

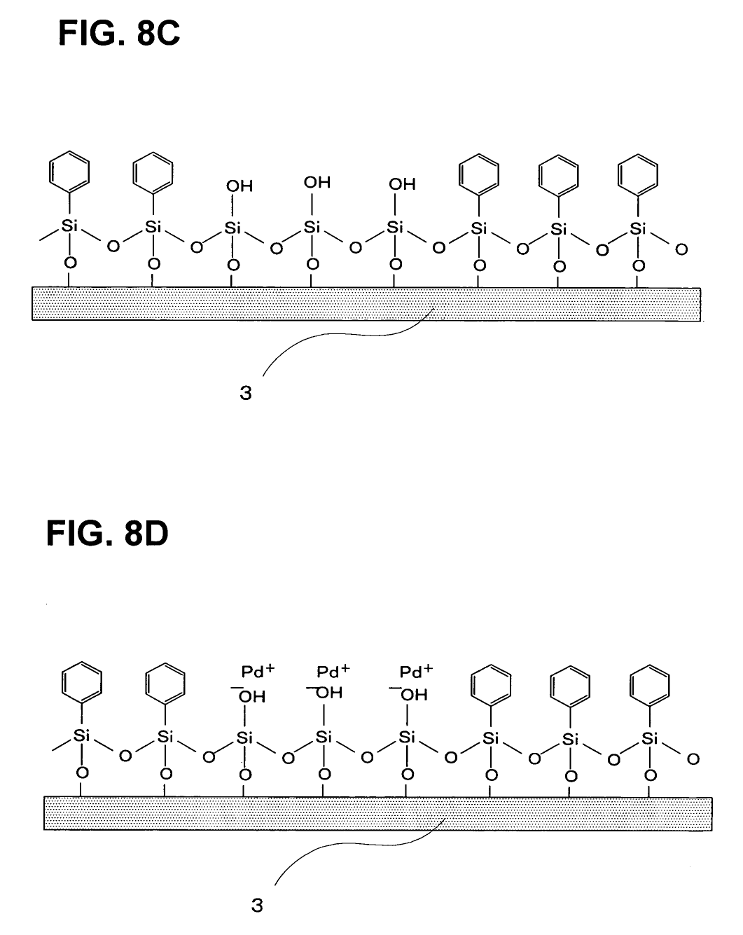

Now the formation of a SAM and the formation of an electrolytic plating layer according to the present invention will be described with reference to FIGS. 7A-D and FIGS. 8A-D. FIG. 8A is a diagram depicting an image when a SAM is formed on a substrate using phenyltrichlorosilane (C₆H₅SiCl₃). The chlorine of phenyltrichlorosilane reacts with the moisture in the atmosphere and generates a hydroxy group, and the hydroxy group bonds to the substrate. It is supposed that the hydroxy groups are further condensed to form a polysiloxane bond, forming a plane structure with silicon being mutually bonded via oxygen, on which the phenyl groups are rising. As FIG. 7A shows, the SAM 71 is formed on both the ribs 9 and between the ribs 75.

In this status, a part of the SAM is activated so that a substance to be a plating catalyst can adhere thereto. For example, as FIG. 8B shows, UV rays are selectively irradiated between the ribs 75 (shown by the arrow marks in FIG. 8B) through a photo mask 81. If the moisture in the atmosphere is appropriately maintained at this time, the phenyl group is removed and a hydroxy group is generated in areas where UV rays are irradiated, as shown in FIG. 8C, and activated areas 72, shown in FIG. 7B, can be acquired.

Then a palladium chloride solution is introduced onto this SAM, for example. By this processing, the plating catalyst (a palladium catalyst in this case) attaches onto the SAM, and the plating catalyst layer 73 can be obtained as shown in FIG. 7C. The chemical form of this plating catalyst is not clear, but in this particular embodiment, it is estimated that the palladium is attracted to the negative polarity of the hydroxy group of the SAM. Although FIG. 8D shows a status where Pd⁺ is thus attracted and attached, actually it is not clear whether it is Pd+or a positively charged Pd metal.

As long as it is within the scope of the essential character of the present invention, any compound other than a palladium chloride solution can be used. Examples are compounds of silver, gold and platinum. Positively charged particles of palladium, silver, gold, platinum or the like may be used as a substance to be a plating catalyst. The particles of palladium, silver, gold, platinum or the like may be dispersed in a solvent and introduced onto a SAM.

Then an electroless plating solution is introduced onto this SAM. As the electroless plating solution, any known solution can be used. Examples are cobalt, copper and nickel solutions. A solution of Co is preferable. By this, the electroless plating layer 74 can be formed, as shown in FIG. 7D. After this, the electrolytic plating layer can be formed on the electroless plating layer 74 by performing electrolytic plating by a known method.

The above is an example where a part of the SAM which is initially inactive is activated so that a substance to be a plating catalyst can adhere thereto, however the scope of the present invention is not limited to this. When a part of a SAM which is initially active uniformly (that is a part where the plating catalyst layer is not to be formed) is deactivated by UV rays or the like, the SAM is considered to have a part that is activated as a result. Accordingly, such a method also is within the scope of the present invention.

The present invention can decrease cost and improve yield, since it allows forming electrodes easily even if the space between the ribs is deep and narrow. So it is particularly effective when there are ribs that are high with a space between the ribs being narrow, like in the case of a substrate for PDP. More specifically, the present invention is advantageous when the height of the ribs is in a range of 100 to 250 μm, and the space between the ribs is in a range of 50 to 330 μm. The width of the rib is not really a critical factor. As examples of the forms of ribs, enumerated are known forms such as a stripe and a stripe with bending (meandering). In FIG. 2, the height of the ribs is shown by H, and the space between ribs is shown by W.

The electrodes can be formed and the substrate for a gas discharge panel can be fabricated as described above. If this substrate for a gas discharge panel is used, the manufacturing costs can be decreased and the yields can be improved, when gas discharge panels such as PDPs are manufactured, or when gas discharge panel display devices such as a flat display television devices are manufactured, by combining the substrate with a counter substrate having a required structure. Also, since the manufacturing steps are simplified and made easy, a quality improvement can be expected for the substrate for a gas discharge panel, gas discharge panel, and gas discharge panel display device according to such methods.

### EXAMPLE

Examples of the present invention will now be described in detail.

### Example 1

A sandblast-resistant resist layer (made by Nippon Synthetic Chemical Industry: Dry Film Resist) with a desired pattern is laminated onto the surface of a glass substrate for PDP (e.g. soda lime glass, high-strain-point glass or the like), and is subjected to patterning.

Abrasive particles for glass cutting (made by Fuji Seisakusho: WA #600-#1200, material: aluminum oxide) are blasted onto the substrate to cut the glass. Then the resist layer is peeled and the glass substrate on which ribs are formed is fabricated.

A SAM, comprised of material that can be activated so that a substance to be a plating catalyst can adhere thereto, is formed on the surface of this glass substrate. An example of the material that can form a SAM is phenyltrichlorosilane (hereafter PTCS).

For the method of forming a PTCS film (SAM), the following processing method can be used, for example. At first, the substrate is cleaned by ultrasonic cleaning with pure water (>17.6 MΩ·cm), soaked in a solution of HCl: CH₃OH=1:1 (volume ratio) for 30 minutes, and then cleaned again with pure water. After soaking in concentrated sulfuric acid for 30 minutes, the substrate is soaked in boiling pure water for 5 minutes. Then the substrate is cleaned with acetone. This substrate is then soaked in an absolute toluene (99.8%, made by Aldrich) solution containing 1% by volume of PTCS (made by Aldrich) for 5 minutes under a nitrogen atmosphere. Then the substrate is dried for 5 minutes at 120° C. to promote the volatilization of the residual solvent and the chemical adsorption of the SAM. By this, the PTCS film can be formed on the surface of the glass substrate.

Regarding this PTCS film, UV rays are irradiated onto areas where electrode wires are to be formed, through a photo mask with openings, so that the phenyl group in the molecules of the PTCS film (SAM) formed on the substrate chemically reacts with water molecules in the atmosphere to turn into a silanol group. The silanol group on the surface is hydrophilic, and when the substrate is soaked in an aqueous solution, H⁺ ions are detached from the —OH groups to form —O⁻, and the surface of the PTCS film to which UV rays are irradiated, becomes negatively charged.

If this substrate having a negatively charged pattern is soaked in a palladium chloride solution, for example, the palladium chloride is dissolved into the water, and Pd²⁺ ions in the aqueous solution are adsorbed onto the negatively charged pattern by Coulomb's force to form a pattern of the palladium catalyst that corresponds to the electrode wires. For the aqueous solution of the palladium chloride, a solution of palladium chloride, 0.25-0.4 g: hydrochloric acid, 1 mL : water, 1 L, is used, and a palladium catalyst pattern is formed after 15-60 seconds of soaking, for example.

If the substrate on which the palladium catalyst pattern is formed is soaked in an electroless plating solution, metal deposition advances, and a metal film is formed on the palladium catalyst pattern. For example, Co is plated on the palladium catalyst pattern by using Conbus-P (made by World Metal LLC, 1:1 (volume ratio) mixed solution of Conbus-P-M and Conbus-P-K) as an electroless plating solution.

If necessary, Cu may be layered by electrolytic plating using the electroconductive pattern of Co.

### Example 2

In Example 1, an organic silane compound (example: PTCS) having a phenyl group is used as the compound for forming a SAM, but a SAM can also be formed with octadecyltrichlorosilane (hereafter OTC) which does not have a phenyl group.

In this case, an OTS SAM can be formed by soaking a glass substrate for which pre-processing such as cleaning has been performed, in a toluene solution containing 1% by volume of OTS for 5 minutes. By irradiating UV rays onto this SAM through a photo mask having openings according to a desired pattern, a pattern of silanol groups is formed by the UV rays. A methyl group remains in the non-irradiated areas. Hereafter the substrate can be processed in the same way as Example 1.

1. A manufacturing method for a substrate for a gas discharge panel, comprising:
forming a self-assembled monolayer on a rib formation surface of a substrate for a gas discharge panel;
activating a part of said self-assembled monolayer so that a substance to be a plating catalyst can adhere thereto;
forming the plating catalyst by causing said substance to be the plating catalyst to adhere to said activated part; and
forming an electroless plating layer on the top of said part of the self-assembled monolayer by an electroless plating method using said plating catalyst.

2. The manufacturing method for a substrate for a gas discharge panel according to claim 1, further comprising performing electrolytic plating using said electroless plating layer as an electrode after forming said electroless plating layer, to form an electrolytic plating layer on the electroless plating layer.

3. The manufacturing method for a substrate for a gas discharge panel according to claim 1, wherein a compound for forming said self-assembled monolayer is an organic silane compound which may be branched and has a group that can be bound to the surface of said substrate and a group that can be activated so that the substance to be the plating catalyst can adhere thereto.

4. The manufacturing method for a substrate for a gas discharge panel according to claim 3, wherein said group that can be bound to the surface of the substrate is a hydroxy group or a group that can be hydrolyzed to form a hydroxy group.

5. The manufacturing method for a substrate for a gas discharge panel according to claim 4, wherein the group that can be hydrolyzed to form a hydroxy group is a halogen group.

6. The manufacturing method for a substrate for a gas discharge panel according to claim 3, wherein the group that can be activated so that said substance to be the plating catalyst can adhere thereto is at least either one of a phenyl group and an alkyl group.

7. The manufacturing method for a substrate for a gas discharge panel according to claim 1, wherein said part of the self-assembled monolayer is activated by irradiation with UV rays through a photo mask so that the substance to be the plating catalyst can adhere thereto.

8. The manufacturing method for a substrate for a gas discharge panel according to claim 1, wherein said plating catalyst is a palladium catalyst.

9. The manufacturing method for a substrate for a gas discharge panel according to claim 1, wherein the thickness of said electroless plating layer is in a range of 0.2 to 0.3 μm.

10. The manufacturing method for a substrate for a gas discharge panel according to claim 2, wherein the total of the thickness of said electroless plating layer and electrolytic plating layer is in a range of 2 to 4 μm.

11. The manufacturing method for a substrate for a gas discharge panel according to claim 1, wherein the height of said ribs is in a range of 100 to 250 μm, and the space between said ribs is in a range of 50 to 330 μm.

12. A gas discharge panel comprising a pair of substrates that face each other, wherein one of said pair of substrates has ribs on the side facing the other substrate, a self-assembled monolayer is formed on the rib formation surface of the substrate having said ribs, a part of said self-assembled monolayer is activated so that a substance to be a plating catalyst can adhere thereto, the plating catalyst is formed by causing said substance to be the plating catalyst to adhere to said activated part, and an electroless plating layer is formed on the top of said part of the self-assembled monolayer by an electroless plating method using said plating catalyst.

13. The gas discharge panel according to claim 12, wherein electrolytic plating is performed using said electroless plating layer as an electrode after said electroless plating layer is formed, so that an electrolytic plating layer is formed on the electroless plating layer.

14. The gas discharge panel according to claim 12, wherein a compound for forming said self-assembled monolayer is an organic silane compound that may be branched and has a group that can be bound to the surface of said substrate and a group that can be activated so that the substance to be the plating catalyst can adhere thereto.

15. The gas discharge panel according to claim 14, wherein said group that can be bound to the surface of the substrate is a hydroxy group or a group that can be hydrolyzed to form a hydroxy group.

16. The gas discharge panel according to claim 15, wherein said group that can be hydrolyzed to form a hydroxy group is a halogen group.

17. The gas discharge panel according to claim 14, wherein the group that can be activated so that said substance to be the plating catalyst can adhere thereto is at least either one of a phenyl group and an alkyl group.

18. The gas discharge panel according to claim 12, wherein said part of the self-assembled monolayer is activated by irradiation with UV rays through a photo mask so that the substance to be the plating catalyst can adhere thereto.

19. The gas discharge panel according to claim 12, wherein said plating catalyst is a palladium catalyst.

20. A gas discharge panel comprising a pair of substrates that face each other, wherein:
one of said pair of substrates has ribs on the side facing the other substrate; and
a self-assembled monolayer having a polysiloxane structure, a plating catalyst layer, and an electroless plating layer are provided in this sequence between the ribs on the rib formation surface of the substrate having said ribs.

21. The gas discharge panel according to claim 20, wherein said layers further comprises an electrolytic plating layer.

22. The gas discharge panel according to claim 12, wherein the thickness of said electroless plating layer is in a range of 0.2 to 0.3 μm.

23. The gas discharge panel according to claim 20, wherein the thickness of said electroless plating layer is in a range of 0.2 to 0.3 μm.

24. The gas discharge panel according to claim 13, wherein the total of the thickness of said electroless plating layer and electrolytic plating layer is in a range of 2 to 4 μm.

25. The gas discharge panel according to claim 21, wherein the total of the thickness of said electroless plating layer and electrolytic plating layer is in a range of 2 to 4 μm.

26. The gas discharge panel according to claim 12, wherein the height of said ribs is in a range of 100 to 250 μm, and the space between said ribs is in a range of 50 to 330 μm.

27. The gas discharge panel according to claim 20, wherein the height of said ribs is in a range of 100 to 250 μm, and the space between said ribs is in a range of 50 to 330 μm.
